(19) United States
(12) Patent Application Publication
(10) Pub. No.: US 2019/0247934 A1
(43) Pub. Date: Aug. 15, 2019

(54) RK Jig Guide

(71) Applicant: Storm Deleon Farmer, Dayton, OH (US)

(72) Inventor: Storm Deleon Farmer, Dayton, OH (US)

(21) Appl. No.: 15/893,210

(22) Filed: Feb. 9, 2018

(51) Int. Cl. B23B 47/28; B23P 6/00

(52) U.S. Cl. CPC B23B 47/287; B23B 2247/12; B23P 6/00

(57) ABSTRACT

A gas meter index repair apparatus with method for removing the gas meter index that has suffered broken attachment screws during the replacement or AMI\AMR upgrade process.

Previously as this damage to the meter index occurred, the only alternatives available were to replace the gas meter or manually drill and tap the broken attachment screws which would allow a high risk of puncturing the gas meter case causing a rapid release of highly flammable and explosive gas. These alternatives would incur multiple premise visits with interrupting the flow of gas to the user.

The RK Jig Guide apparatus connects to the available gas meter index attachment screws and aligns itself with the damaged index cover attachment screws offering perfect alignment to mechanically remove the broken attachment screws allowing their replacement without interrupting the flow of gas to the end user or creating a safety hazard.

This apparatus can be adapted and utilized for most residential gas meter installations. The RK Jig Guide apparatus includes a mounting assembly plate, various index mounting screws, complete detailed written instructions as well as companion video.

The RK Jig Guide is very user friendly and allows the entry level technician, such as a Meter Reader to successfully replace the meter index and cover on the first visit.

### FIELD OF THE INVENTION

This invention relates generally to gas distribution systems and more particularly to apparatus and method for the removal and installation of gas meter indexes without interruption of service.

### BACKGROUND OF THE INVENTION

Although natural gas meters generally operate in a reliable and trouble free manner for a number of years, the gas industry has been in the process of installing AMI\AMR devices to retrofit the existing gas meter for the automated product usage recording process. Due to accuracy concerns and estimated customer usage bills, regulatory agencies who have jurisdiction over gas utility companies demand prompt index reads for customer billing. AMI\AMR installation is occurring throughout the country and the RK Jig Guide greatly improves the process.

When a gas meter index cannot be replaced on the initial visit due to the damaged index cover attachment screws, the entire gas meter must be replaced. If the supply of gas to the user is interrupted, even momentarily, pilot lights will be extinguished and at the very least, this then requires the service technician to enter the home or business and re-light the pilot lights for each of the user's appliances. Additional health and safety concerns arise in cases where property owners cannot be contacted for an extended period of time following a disruption of service. The RK Jig Guide eliminates these concerns.

### BRIEF SUMMARY OF THE INVENTION

A gas meter defective index cover attachment apparatus and method for removing a gas meter index that has suffered broken attachment screws during the replacement or AMI\AMR upgrading process.

The RK Jig Guide apparatus connects to the available gas meter index attachment screws and aligns itself with the damaged index cover attachment screws offering perfect alignment to mechanically remove the broken attachment screws allowing their replacement without interrupting the flow of gas to the end user or creating a safety hazard.

### BRIEF DESCRIPTION OF THE DRAWINGS

FIG. 1 show the front profile of the RK Jig Guide, this view shows how the RK Jig Guide would look when attached to a gas meter facing the installer, all Mounting screws and Cylinder holes can be viewed.

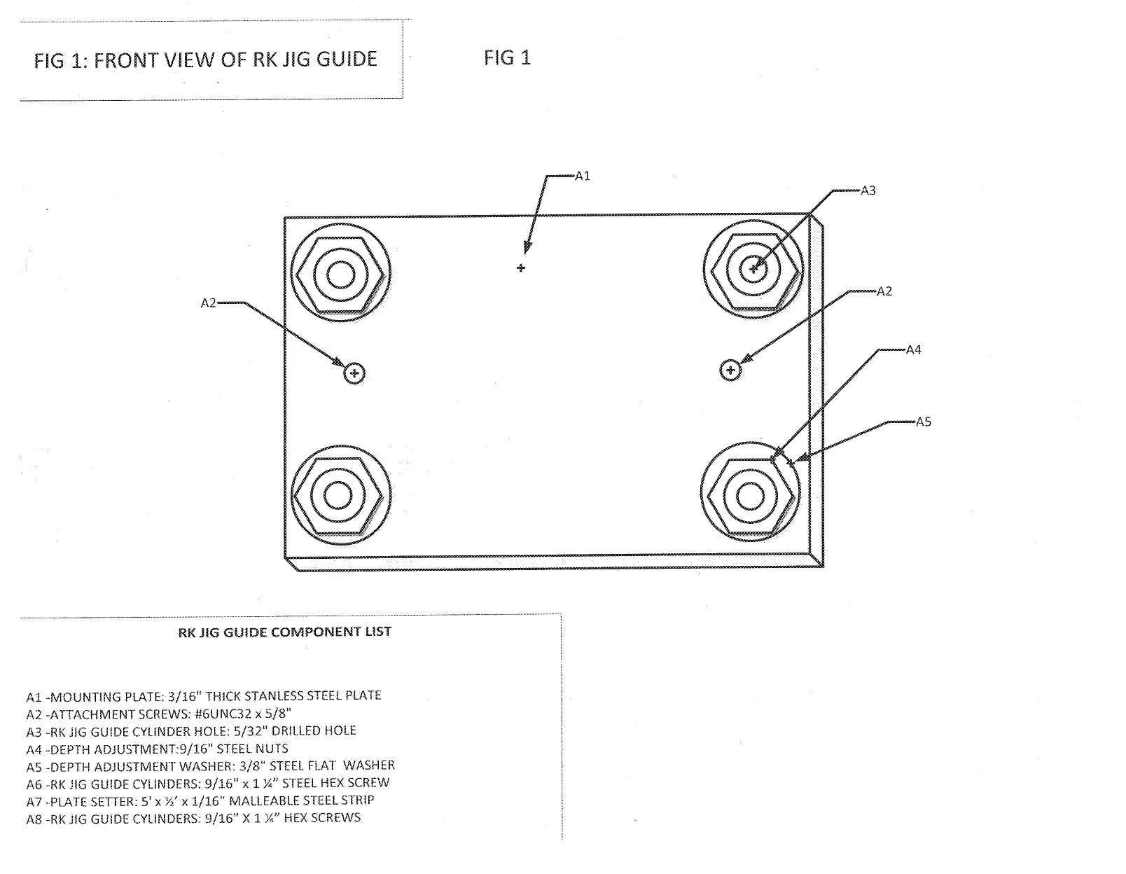

FIG. 2 shows a side profile of the RK Jig Guide, this view shows a portion of the Plate Setter.

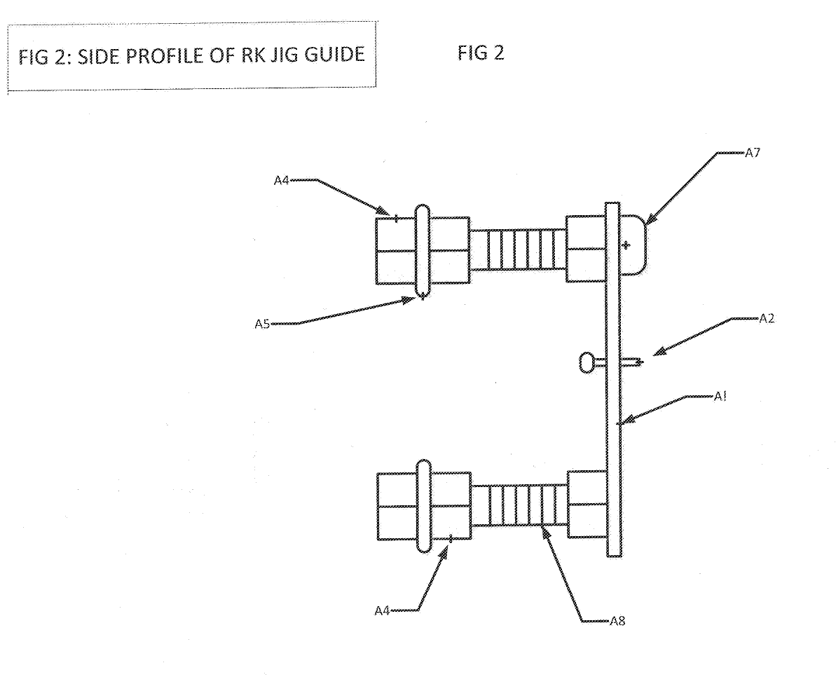

FIG. 3 shows a back view of the RK Jig Guide, this view shows the entire Plate Setter.

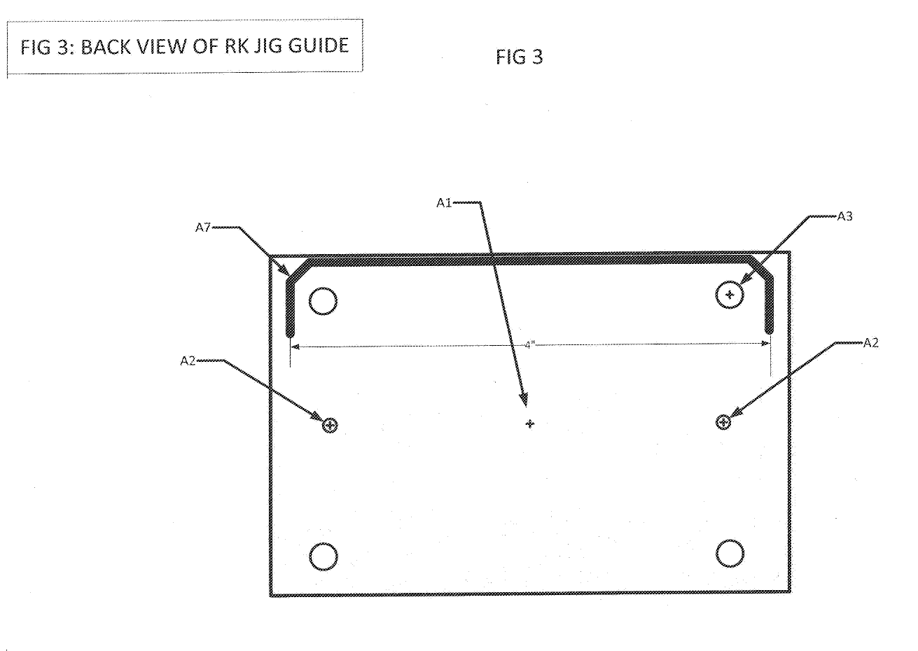

### DETAILED DESCRIPTION OF THE INVENTION

The RK Jig Guide has steel plate with four fixed cylinder attached. These four cylinders allow for a 5/32″ drill bit to penetrate into the broken index cover screws on a Rockwell gas meter. Each cylinder has two 9/16″×1¼″ steel nuts and one ⅜″ steel flat washer for drill bit depth adjustment. A malleable steel strip on the back of the apparatus called the plate setter allows quick alignment of the index attachment screws. Two #6 UNC-32×⅜″ steel screws called the index attachment screws allow for the apparatus to be secured to the gas meter.

The materials required in building the RK Jig Guide are as listed: four 9/16″×1 1/7 steel hex screws and six 9/16″ steel nuts with same thread size, four ⅜″ steel flat washers, four #10 UNC-24×1″ steel screws, two #6 UNC-32×⅜″ steel screws, one 5″×½″× 1/16″ malleable steel strip, two 3/16″×3″×4½″ steel plates, carbon steel welding wire. Some materials will require machining, ( 3/16″×3″ steel plates come in 3′ sections available from most hardware and home stores).

Tools required are as listed: Drill Press, Metal Grinder, Tap Wrench, Machinist Vice, Drill Press Vice, C-Clamps, Screw driver, Metal file and Chisel, Ball Peen Hammer, two Adjustable Wrenches, 5/32″ Drill bit for hardened steel drilling, 1/16″ Drill bit for hardened steel drilling, 10-24NC metal tap, 6-32NC metal tap, Flux core welder using 0.030 carbon steel welding wire, Wire Brush, metal cutting oil, Rockwell gas meter for size and fitting purposes.

The assembly process starts by creating a template using one 3/16″×3×4¼″ steel plates. This template will allow for multiple RK Jig guides for additional gas meter manufacturers to be created accurately. Using a piece of paper or cardboard and a marker, trace the hole pattern of all four index cover screws and the two index screws of the Rockwell natural gas meter. Once the hole pattern is accurately traced, transfer the hole pattern onto one of the 3/16″×3×4¼″ steel plates. Using the drill press and the 1/e″ drill bit, bore out the two center index holes and remove any metal shavings, next use the tap wrench with the 6-32NC tap to thread the two holes; it is very important that the thread and holes are straight. Using the 5/32″ drill bit, bore out the four index cover screw holes and remove any metal shavings, using the 10-24NC tap, thread the four index cover screw holes and remove any metal debris.

After all the holes are bored and tapped on the template, mount the template using the #6 UNC-32×⅜″ index attachment screws to the Rockwell natural gas meter making ensuring that all the template holes align with the gas meter index attachment screw holes. If all holes are perfectly aligned, it is time to make another plate, take another 3/16″×3×4¼″ steel plate and using two 2″ clamps, clamp the created template to the blank steel plate so that both steel plates are square with each other. Once the plates are clamped together, clamp the pair of to the drill press using the drill press vise. Make sure the template plate is facing up and use the template holes to drill out the exact hole pattern as the template, this will require using the 5/32″ drill bit for the index cover screw holes and the ⅛″ drill bit for the index screw holes. It is important not to damage the template during this machining process. After the holes are bored into the blank steel plate, be sure to remove any metal shavings. Remove the two plates from the drill press vise and place them on the machinist vise with the template plate facing up. Using the 10-24NC tap, insert it through the existing threaded holes on the template and thread the index cover holes on the bottom plate so that the holes will have exacting threaded holes. Install a #10 UNC24×1″ steel screw in threaded hole and remove the clamps holding the plates together. Next using the 6-32NC tap, insert through the existing threaded index holes, thread the bottom plate and install two #6 UNC-32×⅜″ steel screws in the threaded index holes. Once all the screws are in place they can now be removed and the two plates can be set aside separately, the template plate will not be needed for the rest of the manufacturing process and can be placed aside until the manufacturing another RK Jig Guide.

The next step is the machining of the four 9/16″×1¼″ steel hex screws. Place a 9/16″ socket and on the drill press vise so that the opening for the bolt head is facing up and is straight. Place one of the steel hex screws in the socket so that the hex screws head is facing down, you may need to use a 9/16″ steel nut with the hex screw to ensure the screw does not move while in the 9/16″ socket when drilling. Using the drill press and the 5/16″ drill bit, center drill the steel hex screw until the drill bit is completely through the hex screw head. Repeat this process with the remaining three 9/16″×1¼″ steel hex screw. Once the boring is complete on all hex screws, place them on the machinist vise so that the hex screw heads are facing up and are straight. Using the 10-24NC tap thread the hole on the hex screw heads at ¼″ depth. Clean out any metal debris that will be present after tapping the holes.

The next step is to mount all four 9/16″ steel hex screws to the 3/16″×3×4½″ steel plate created earlier. Using the #10 UNC-24×1″ steel screws, thread the screws into all four of the index cover screws holes on the 3/16″×3′×4½″ steel plate. Next insert all four hex screws using the threaded holes on the hex screw heads thread them onto the screws threads attached to the steel plate. Tighten the Hex Bolt to the steel plate reversing the screws out. The #10 UNC-24×1″ steel screws will start to back out of the steel plate, this is normal as long as the hex screw heads are tightened to the steel plate attached by the steel screw. The four hex screws should now resemble four legs on a table with the steel plate being the table top. It is now time to weld all four hex screws to the steel plate using the 0.030 carbon steel welding wire and welder. After welding, use the wire brush and metal cold chisel to remove any impurities from the welding process. After welding has cooled, remove and discard the #10 UNC-24×1″ screws and replace the #6 UNC-32×⅜″ index screws.

Next step is to create and attached the Jig Setter. Take the RK Jig Guide and mount it to the Rockwell gas meter using the #6 UNC-32×⅜″ index attachment screws. Take the 5″×½″× 1/16″ malleable steel strip and form the Jig Setter by using the ball peen hammer and machinist vise to forge the steel strip in the shape of the top portion of the Rockwell natural gas meter index cover mount. Once the shape is correct place the steel strip at the top portion of the mounted RK Jig Guide and using a large clamp, clamp the strip to the Rockwell gas meter and RK Jig Guide. Weld the seam using the 0.030 carbon steel welding wire between the RK Jig Guide and the Jig Setter.

After cooling use the wire brush and metal cold chisel to remove any welding impurities. Use a metal grinder and fine coarse sand paper to remove any rough edges. It is recommended to coat the RK Jig Guide at this time with a rust resistant coating. The last step is to install the 9/16″ depth adjustment nuts and ⅜″ steel flat washers to the RK Jig Guide cylinders. Start by screwing a 9/16″ steel nut′/2″ down on the attached hex screws thread. Place a steel flat washer and install another 9/16″ nut and tighten both nuts against the washer. Repeat this on the last the three attached hex screws or (cylinders)“. Using a 5/32” drill bit, slide the drill bit into each cylinder and bore to ensure everything is perfect alignment. Remove the new RK Jig Guide from the Rockwell gas meter and the RK Jig Guide is complete.

What is claimed:

1. The claimed invention is a jig apparatus that can be attaches to a gas meters index attachment screws for the purpose of drilling out broken and or damaged gas meter index cover screws comprising of:
A steel plate with malleable steel strip formed for the accurate placement of steel plate to attach index attachment screws on a gas meter, and
Four affixed exterior threaded steel cylinders measured to the correct and accurate spacing of a gas meters index cover attachment screws that provide drilling guides for which a drill bit can be inserted, and
Four steel nut and steel flat washer assemblies to allow for drilling depth adjustment.

2. The jig apparatus of claim 1, wherein the apparatus is secured to a gas meter by the index attachment screws the jig apparatus cylinders will align to index cover attachment screw holes allowing for the precise drilling of broken and or damaged index cover screws.

3. The jig apparatus of claim 1, wherein the apparatus is secured to a gas meter by the index attachment screws the jig apparatuses four affixed exterior threaded steel cylinders with steel nut and steel flat washer assemblies provide guides for drill bits to be inserted reducing the risk of inaccurate hole drilling.

4. The jig apparatus of claim 1, wherein the apparatus is secured to a gas meter by the index attachment screws the jig apparatuses affixed exterior threaded steel cylinders with steel nut and steel flat washer assemblies reduce the risk of puncturing the gas meter case with a drill bit when performing broken and or index cover attachment screw drilling.
